(19) United States
(12) Patent Application Publication
(10) Pub. No.: US 2005/0044533 A1
(43) Pub. Date: Feb. 24, 2005

(54) System and method for focused testing of software builds

(75) Inventors: Nathan Eldon Nesbit, Duvall, WA (US); Pankaj S. Lunia, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/642,932

(22) Filed: Aug. 18, 2003

(51) Int. Cl. G06F 9/44

(52) U.S. Cl. 717/124

(57) ABSTRACT

A system for testing a software build is presented. A current software build is compared to a reference software build, typically a known, previous build. The comparison identifies those areas in the current software build that have changed with regard to the reference software build. The identified areas are used by a coverage analysis process to determine a focused test suite to test the modified areas of the current build. The test coverage analysis uses information in a master test suite to determine the focused test suite. The focused test suite is used by a test process to test the modified areas of the current software build. The coverage analysis process may also identify those areas of the current software build that cannot be tested using the tests in the master test suite. A report is generated identifying those areas that are not covered by the focused test suite.

### FIELD OF THE INVENTION

The present invention relates to software development, and in particular, to testing software builds.

### BACKGROUND OF THE INVENTION

Many software applications today are both large and complex. Many involve millions of lines of code, scattered among thousands of source files. Due to the size, the intricacy, and the complexity of current software applications, it is a difficult task for software providers to fully test all facets of their software applications.

When a software application is relatively small and simple, “brute force” testing, i.e., exercising/testing each feature or aspect of an application, by quality assurance personnel may be sufficient to fully test an application. However, most software providers have turned to automated test suites to test their products and identify problem areas. Yet even these automated test systems resort to “brute force” testing: using large, predetermined, test suites that exercise all facets of an application to discover and identify problem areas.

There are several problems related with the current test systems. First, brute force testing is extremely time consuming, even for automated test systems, when the subject matter being tested, i.e., the software application, is large and complex. One of the reasons that brute force testing is so time consuming is that test versions of software applications typically include large amounts of symbolic information in order to identify locations that are exercised, and identify those areas of the application that have problems. Because of the large amount of data associated with a testable version of an application, merely executing the application is time consuming. For example, after generating a software build for testing, it is not uncommon to let an automated testing system to take several days to complete a single pass of a test suite.

A second problem associated with the current test systems is that the current test systems do not focus on specific modifications made to the software. Most corrections/modifications to software applications are made as small, incremental changes to localized areas of the source code. Thus, while initially a software application should be fully tested by the entire test suite, perhaps by brute force testing, subsequent testing focused only on areas of the application that are affected by modifications to the source code could substantially reduce the amount of time involved to test the application, and assure adequate test coverage. Current efforts to target testing to specific changes are based on intuition, even guessing. Thus, if an area of an application is known to have been changed, a quality assurance person may attempt to test that area using test believed to be related. However, without an analysis of the changes made, such testing is unlikely to exercise areas of the application that are not intuitively related to, or otherwise dependant on, the modified code. This is especially true when the application is large and complex, as most are.

A third problem that often arises using automated test systems is the inability of the automated test system to test, or even recognize, areas of the source code that fall outside of the test suite's ability to test. For example, it is common for software developers to incrementally add functionality to a software application after the software application's test suite has been developed. This is often referred to as “feature creep.” Due to this “feature creep,” while the test suite may be able to run to completion without detecting any problems in the software application, a newly added feature will remain untested and may present difficult and adverse conditions when executed by a consumer.

What is lacking in the prior art is a system and method for efficiently testing software application builds. A test system should determine which areas of the application have been modified, and tailor a test suite to focus on exercising that part of the software application that has been affected by the modified areas. The test system should further be able to recognize and report specific areas within the application that fall outside of the current test suite's ability to exercise and test.

### SUMMARY OF THE INVENTION

A method for determining a test suite for a current software build is provided. A current software build is compared to a reference software build to determine those areas of the current software build that have changed. The comparison results, identifying those areas of the current software build that have been changed, are used by a coverage analysis process. The coverage analysis process uses information in a master test suite and the comparison results to determine a focused test suite: a set of tests selected to cover those areas of the current software build that have been modified with regard to the reference software build. The focused test suite may be used by a test process to exercise the modified areas of the current software build. The coverage analysis process also determines those areas of the current software build that have changed with regard to the reference software build that are not covered by any of the tests in the master test suite.

A system for testing a current software build is provided. The system includes a processor, a memory, and a storage device. The storage device stores a reference build and a master test suite for testing a current software build. The system further includes a comparison module that obtains a current software build and compares it to the reference software build in the storage area to determine those areas of the current software build that have been modified with regard to the reference software build. The system still further includes an analysis module. The comparison module creates comparison results that are used by the analysis module in conjunction with information in the master test suite. The analysis module generates a focused test suite from the tests in the master test suite. The tests in the focused test suite are selected according to their coverage of the modified areas of the current software build. The analysis module also identifies those areas of the current software build that are not covered by the tests of the master test suite.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrating an exemplary computer system for implementing aspects of the present invention;

FIG. 2 is a pictorial diagram illustrating a process for building and testing a software application as found in the prior art;

FIG. 3 is a pictorial diagram illustrating a process for building and testing a software application in accordance with the present invention; and

FIG. 4 is a flow diagram illustrating an exemplary method for efficiently testing a software application in accordance with the present invention.

### DETAILED DESCRIPTION

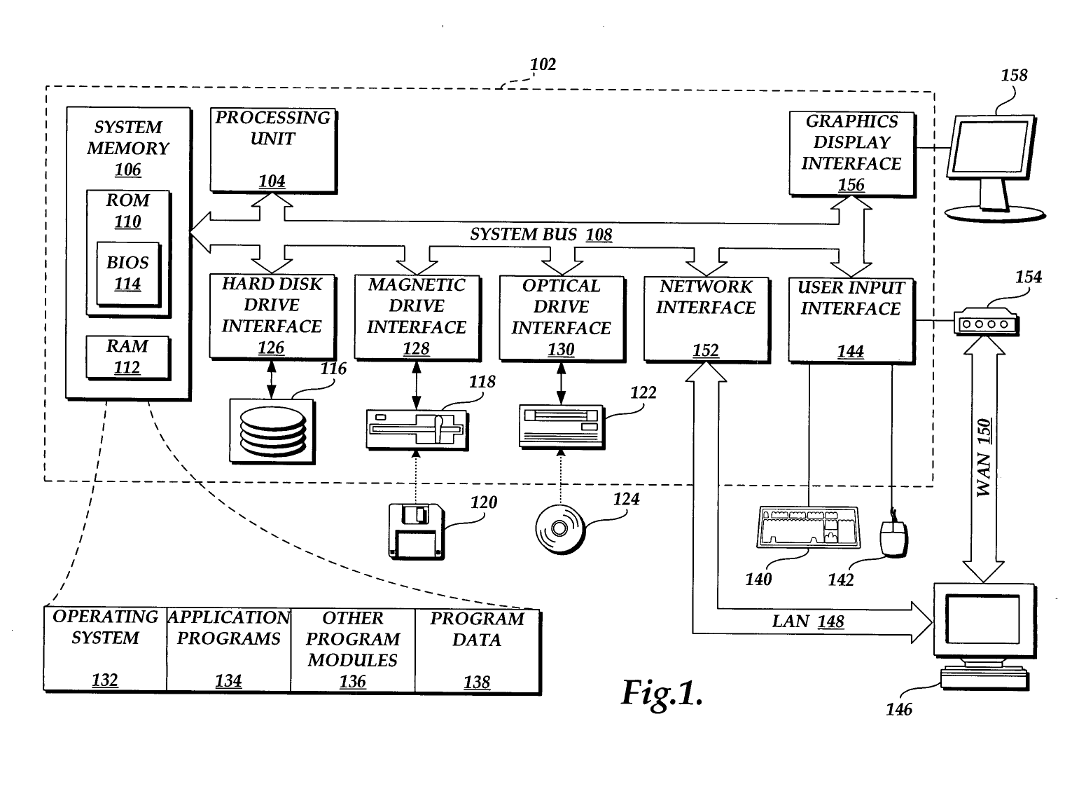

FIG. 1 and the following discussion are intended to provide a brief, general description of a computing system suitable for implementing various features of the invention. While the computing system will be described in the general context of a personal computer usable as a stand-alone computer, or in a distributed computing environment where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, and the like.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc., that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer information between elements within the personal computer 102, such as during startup, is stored in ROM 110.

The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, including magnetic cassettes, flash memory cards, digital video disks, Bernoulli cartridges, ZIP disks, and the like, may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB).

A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a tablet computer, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The logical connections depicted in FIG. 1 include a local area network (LAN) 148 and a wide area network (WAN) 150. Such networking environments are commonplace in offices, enterprise-wide computer networks, intranets, and the Internet. It should be appreciated that the connections between one or more remote computers in the LAN 148 or WAN 150 may be wired or wireless connections, or a combination thereof.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the system.

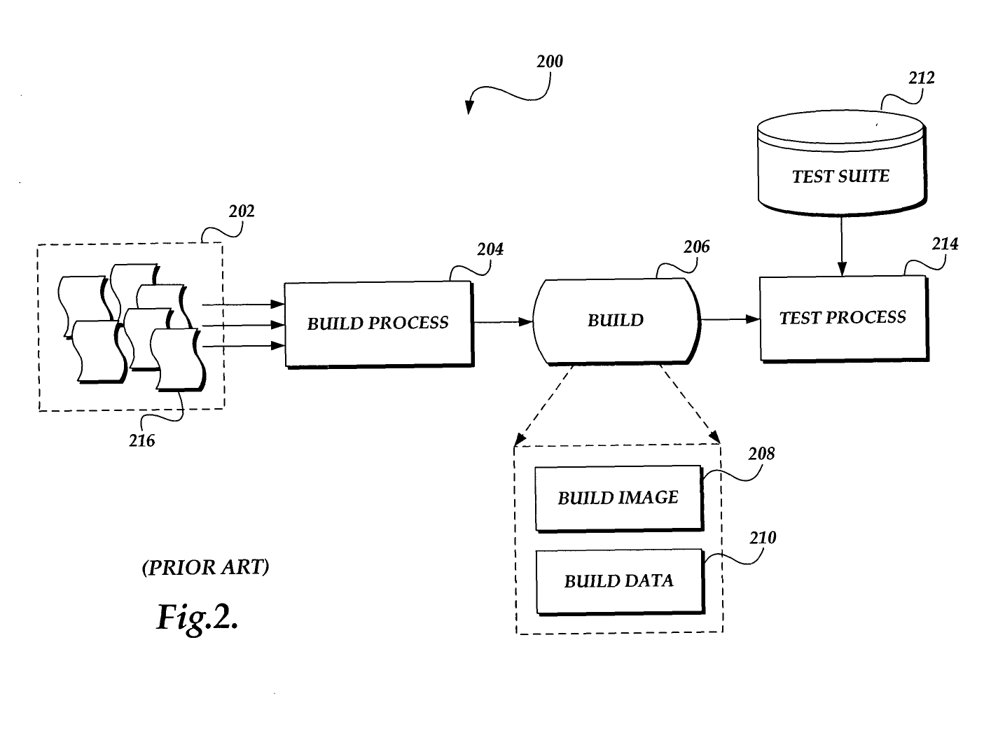

FIG. 2 is a pictorial diagram illustrating a process 200 for building and testing a software application, as found in the prior art. Source modules 202, which include source files, include files, definition files, and the like, are retrieved by a build process 204 that generates a build 206. The build 206, generated by the build process 204, typically includes a build image/executable 208 and other associated build data 210. As those skilled in the art will recognize, the build data 210 includes things including, but not limited to: symbolic information that identifies routines, variables, modules, and the like; data files; icon files; even the source files. Those skilled in the art will also recognize that the build image 208 and the build data 210 may be included in a single file as illustrated in FIG. 2, or alternatively, may be distributed among multiple files.

After the build 206 has been generated by the build process 204, a test process 214 retrieves a test suite 212 and executes the tests in the test suite to determine whether the build functions as specified. As previously discussed, the test process 214 typically exercises the tests in the test suite 212 in a “brute force” manner, whether all of the source files 202, or only a single module, such as source file 216, are modified.

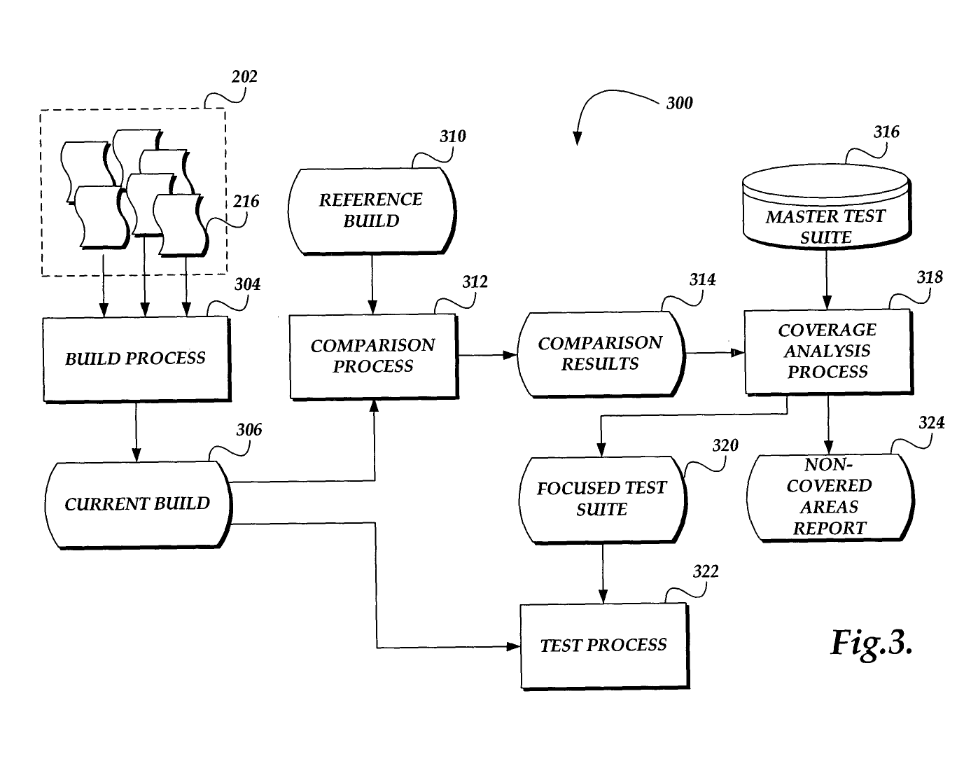

FIG. 3 is a pictorial diagram illustrating a process 300 for building and testing a software application in accordance with aspects of the present invention. Similar to the prior art system described in FIG. 2, a build process 304 retrieves source modules 202 and generates a current build 306, typically comprising an executable image and associated build data. However, in contrast to the prior art system of FIG. 2, once the current build 306 has been generated by the build process 304, a comparison process 312 obtains the current build 306 and compares the current build to a reference build data 310 to determine what areas of the current build have been changed in regard to the reference build. This comparison may be based on a variety of considerations, such as, but not limited to, whether the code for a particular routine has been modified, whether a source file's modified date is different than the corresponding file's date for the reference build 310, or whether a sub-routine, upon which a critical code segment relies, has been changed, to name a just few. Those skilled in the art will appreciate that other factors may be used or considered to determine if areas of a current build have been modified in regard to a reference build, all of which are contemplated as falling within the scope of the present invention.

The results of the comparison process, i.e., the areas of the current build 306 that have been modified with regard to the reference build 310, are place in a report referred to as the comparison results 314. The comparison results 314 are used by a coverage analysis process 318 to determine a suite of tests that may be used to test those areas of the current build 306 that have been modified. The coverage analysis process 318 retrieves information from a master test suite 316 to determine a test suite to test the areas in the current build 306 that have been modified with regard to the reference build 310. While the master test suite 316 is similar to a typical test suite 212 (FIG. 2) found in the prior art, it comprises additional information not found in the prior art. In particular, the master test suite 316 includes information associating tests in the master test suite with specific areas of the current build 306. Thus, based on the areas identified in the comparison results 314, the coverage analysis process 318 generates a focused test suite 320. As mentioned, the focused test suite 320 includes tests from the master test suite 316 that will exercise those areas of the current build 306 that have changed in regard to the reference build 310. The focused test suite 320 is then used by a test process 322 to exercise the current build 306, and in particular, aspects of the current build that have been modified in regard to the reference build. It will be appreciated that the test process 322 may be a manual test process or an automated test process.

In addition to generating a focused test suite 320, the coverage analysis process 318 may also generate a non-covered areas report 324. The non-covered areas report 324 identifies the modified areas of the current build 306 that cannot be exercised using any of the tests of the master test suite 316. In other words, the coverage analysis process 318 recognizes those areas of the current build 306 that fall outside of the master test suite's ability to test. As mentioned previously, one reason this situation may occur is the addition of features to the current build 306 that were not found or tested in the reference build 310.

While the above description of the process for building and testing a software application compares the current build 306 to a reference build 310, it is for illustration purposes, and should not be construed as limiting upon the present invention. Those skilled in the relevant art will recognize that other information associated with an application may be used to identify a focused test suite. For example, according to an alternative embodiment, rather than comparing a current build 306 to a reference build 310, a current code freeze may be compared to a reference/previous code freeze in order to identify areas of change and create a focused test suite. As those skilled in the art will recognize, a code freeze is a snapshot of the source code that is used to create a build.

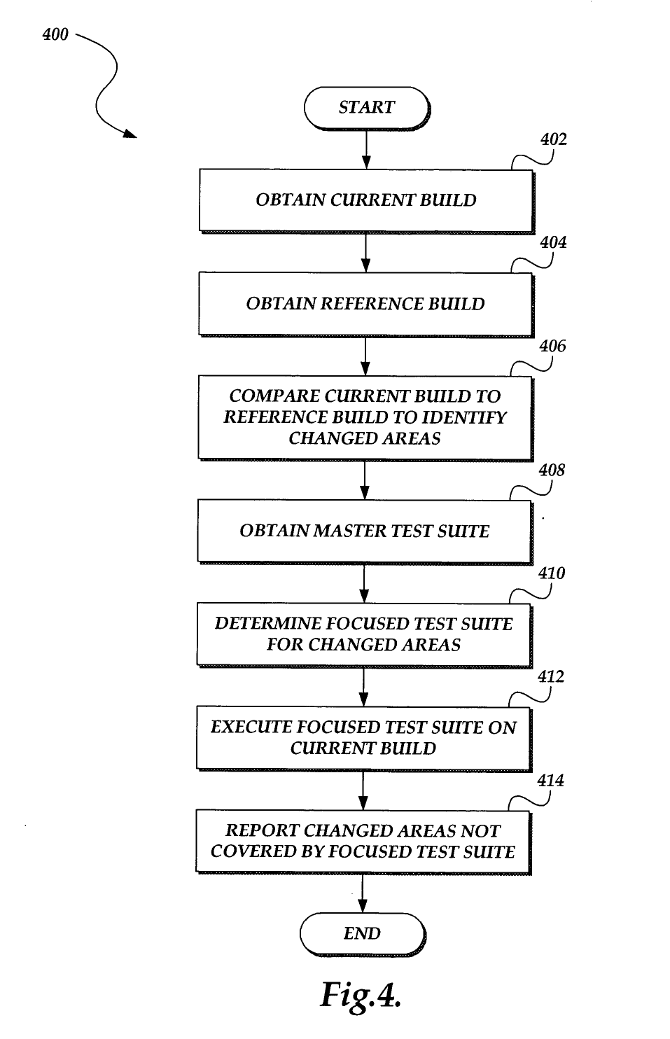

FIG. 4 is a flow diagram illustrating an exemplary method 400 for testing a software application, in accordance with the present invention. Beginning at block 402, a current build 306 is obtained. At block 404, a reference build 310 is obtained. At block 406, the current build 306 is compared to a reference build 310 to identify areas of the current build that have been changed in regard to the reference build. At block 408, a master test suite 316 is obtained. At block 410, the comparison results 314, determined in block 406, are analyzed with respect to information in the master test suite 316, to determine a focused test suite 320 to exercise those areas of the current build 306 that have been modified with regard to the reference software build 310. At block 412, the focused test suite 320 is executed on the current build 306. At block 414, those areas in current build 306 that were modified with regard to the reference build 310 that cannot be covered by any of the tests within the master test suite 316, are reported. Thereafter, the routine 400 terminates.

In addition to generating a focused test suite for efficiently testing a software build, aspects of the invention may be utilized in other beneficial ways. For example, as a software application approaches its release date in the development cycle, it is important for the software provider to know what areas of an application are stable, and what areas are still undergoing significant modifications. Thus, in addition to creating a focused test suite 320 for a current software build, by tracking the focused test suites between builds, or more specifically, tracking those areas of the software build targeted by the focused test suite, a software provider gains an accurate indication of those areas that may be considered stable, and those areas that are still in flux.

While the preferred embodiment of the invention has been illustrated and described, it will be appreciated that various changes can be made therein without departing from the spirit and scope of the invention.

1. A method for determining a test suite for a current software build, comprising:
obtaining a current software build;
obtaining a reference software build;
comparing the current software build to the reference software build to identify areas of the current software build that have been modified with regard to the reference software build; and
selecting a focused test suite from a master test suite according to the identified areas, such that a test in the focused test suite, when executed, will exercise at least one identified area of the current software build that has been modified with regard to the reference software build.

2. The method of claim 1 further comprising generating information identifying areas of the current software build that have been modified with regard to the reference software build that cannot be exercised by at least one test in the master test suite.

3. The method of claim 1, wherein the current software build is compared to the reference software build according to the modification dates of corresponding source files found in both the current software build and the reference software build.

4. The method of claim 1, wherein the current software build is compared to the reference software build by comparing the executable codes for a routine found in both the current software build and the reference software build.

5. A computer system for determining a test suite for a current software build, the system comprising:
a processor; and
a memory, wherein the memory stores:
a reference software build;
a master test suite comprised of tests for testing the current software build;
a comparison module which, when executed by the processor, obtains the current software build and compares it to the reference software build, identifying those areas of the current software build that have changed with regard to the reference software build; and
an analysis module, which when executed by the processor, determines a focused test suite from the master test suite according to the identified areas of the current software build that have changed with regard to the reference software build.

6. The system of claim 5, where the analysis module further identifies those areas of the current software build that have been modified with regard to the reference software build that cannot be exercised by at least one test in the master test suite.

7. The system of claim 5, wherein the comparison module compares the current software build to the reference software build according to the modification dates of a source file common to both the current software build and the reference software build.

8. The system of claim 5, wherein the comparison module compares the current software build to the reference software build according to the executable codes for a routine common to both the current software build and the reference software build.

9. A method for testing a current software build, comprising:
obtaining information relating to a current software build;
obtaining information relating to a reference software build;
comparing information relating to the current software build to information relating to the reference software build to identify areas of the current software build that have been modified with regard to the reference software build;
selecting a focused test suite from a master test suite according to the identified areas, such that the focused test suite will exercise the identified areas of the current software build that have been modified with regard to the reference software build when executed; and
testing the current software build using the focused test suite.

10. The method of claim 9 further comprising generating information identifying areas of the current software build that have been modified with regard to the reference software build that cannot be exercised by at least one test in the master test suite.

11. The method of claim 9, wherein information relating to the current software build is compared to information relating to the reference software build according to the modification dates of corresponding source files found in both the current software build and the reference software build.

12. The method of claim 9, wherein information relating to the current software build is compared to information relating to the reference software build by comparing the executable codes for a routine found in both the current software build and the reference software build.

13. A computer system for testing a current software build, the system comprising:
a storage means that stores a reference software build, and also stores a master test suite comprised of tests for testing the current software build;
a comparison means that obtains the current software build, compares the reference software build to the current software build, identifying those areas of the current software build that have changed from the reference software build;
an analysis means that determines a focused test suite from the master test suite according to the identified areas of the current software build that have changed from the reference software build; and
a test means that exercises the focused test suite on the current software build.

14. The system of claim 11, where the analysis means further identifies those areas of the current software build that have been modified with regard to the reference software build that cannot be exercised by at least one test in the master test suite.

15. The system of claim 11, wherein the comparison means compares the current software build to the reference software build according to the modification dates of a source file common to both the current software build and the reference software build.

16. The system of claim 11, wherein the comparison means compares the current software build to the reference software build according to the executable codes for a routine common to both the current software build and the reference software build.

17. A computer-readable medium bearing computer-readable instructions which, when executed, carry out the method comprising:
obtaining a current software build;
obtaining a reference software build;
comparing the current software build to the reference software build to identify areas of the current software build that have been modified with regard to the reference software build; and
selecting a focused test suite from a master test suite according to the identified areas, such that the focused test suite will exercise the identified areas of the current software build that have been modified with regard to the reference software build when executed.

18. The method of the computer-readable medium of claim 17 further comprising testing the current software build using the focused test suite.

19. The method of the computer-readable medium of claim 17 further comprising generating information identifying areas of the current software build that have been modified with regard to the reference software build that cannot be exercised by at least one test in the master test suite.

20. The method of the computer-readable medium of claim 17, wherein the current software build is compared to the reference software build according to the modification dates of corresponding source files found in both the current software build and the reference software build.

21. The method of the computer-readable medium of claim 17, wherein the current software build is compared to the reference software build by comparing the executable codes for a routine found in both the current software build and the reference software build.
